(19) United States
(12) Patent Application Publication
(10) Pub. No.: US 2026/0082339 A1
(43) Pub. Date: Mar. 19, 2026

(54) APPLICATION-AWARE SAR COMPLIANCE

(71) Applicant: Apple Inc., Cupertino, CA (US)

(72) Inventors: Lorenzo BERTIZZOLO, San Francisco, CA (US); Prashant H. VASHI, San Jose, CA (US)

(21) Appl. No.: 19/296,202

(22) Filed: Aug. 11, 2025

Related U.S. Application Data
(60) Provisional application No. 63/696,243, filed on Sep. 18, 2024.

(51) Int. Cl. H04W 52/36; H04B 1/3827

(52) U.S. Cl. CPC H04W 52/367; H04B 1/3838

(57) ABSTRACT

The described embodiments relate to wireless communications, including methods and apparatus to select a specific absorption rate (SAR) limit for cellular wireless transmission by a transmitter of a wireless device based at least in part on knowledge of one or more applications that can generate data for cellular wireless transmission. One or more processors of a wireless device can identify a device operational state that can include information regarding a manner in which the wireless device is being used that can influence selection of an applicable SAR limit for the transmitter of the wireless device.

### CROSS-REFERENCE TO RELATED APPLICATIONS

The present application claims the benefit of U.S. Provisional Application No. 63/696,243, entitled “APPLICATION-AWARE SAR COMPLIANCE,” filed Sep. 18, 2024, the content of which is incorporated by reference herein in its entirety for all purposes.

### FIELD

The described embodiments relate to wireless communications, including methods and apparatus to select a specific absorption rate (SAR) limit for cellular wireless transmission by a transmitter of a wireless device based at least in part on knowledge of one or more applications that can generate data for cellular wireless transmission.

### BACKGROUND

Regulatory bodies in different geographic areas can impose radio frequency (RF) safety rules and/or guidelines that limit exposure by human bodies (or specific parts thereof) to RF radiation by radio transmitters. Manufacturers of cellular wireless devices can comply with regulations that restrict a rate of RF energy that may be absorbed by a human body part, usually expressed by an amount of power, i.e., energy per unit time, (e.g., Watts) per unit weight (e.g., kilograms). A regulatory body, such as the Federal Communications Commission (FCC) in a geographic region, such as the United States, can impose that a cellular wireless device prove compliance with an established regulation regarding specific absorption rate (SAR) limits. Cellular wireless standards organizations can also provide guidance regarding different SAR limits for different radio access technologies (RATs) that use different RF bands.

SAR power limits can be specific to a RAT, an RF band, an amount of RF bandwidth used, a particular transmit antenna port used by the wireless device, among others. In addition, there may be different SAR limits applicable under different use conditions for a cellular wireless device, e.g., adjacent to a user's head, next to a user's body, or at a user's body extremity. Present use of a body extremity SAR limit has been restricted to non-terrestrial cellular wireless transmission, such as for cellular wireless device to satellite receiver transmission, and has not been available for cellular wireless transmission. There is a need to ensure compliance with SAR limits, while choosing with greater flexibility which SAR limit to apply to terrestrial cellular wireless transmission by a wireless device.

### SUMMARY

The described embodiments relate to wireless communications, including methods and apparatus to select a specific absorption rate (SAR) limit for cellular wireless transmission by a transmitter of a wireless device based at least in part on knowledge of one or more applications that can generate data for cellular wireless transmission. One or more processors of a wireless device can identify a device operational state that can include information regarding a manner in which the wireless device is being used that can influence selection of an applicable SAR limit for the wireless device. The device operational state can be based at least in part on a status of one or more applications that are in active use by the wireless device. The one or more processors of the wireless device can select a SAR limit to use based on the identified device operational state and can configure a transmitter of the wireless device in accordance with the selected SAR limit. In some embodiments, the SAR limit includes one of: a head-adjacent SAR limit, a body-adjacent SAR limit, or a body-extremity-adjacent SAR limit. In some embodiments, the one or more processors of the wireless device obtain information regarding expected uses for one or more applications, where the information can be used to determine an applicable SAR limit. In some embodiments, the wireless device includes one or sensors and the one or more processors of the wireless device use information provided by the one or more sensors to determine a device positioning of a transmitter of the wireless device (or of the wireless device as a whole) relative to a user of the wireless device. In some embodiments, the wireless device includes one or more peripherals, such as a camera, microphone, speaker, etc., and the one or more processors of the wireless device use information from one or more of the peripherals to determine a use of the wireless device and an applicable SAR limit based on the determined use of the wireless device. In some embodiments, the body-extremity-adjacent SAR limit provides for a longer sustainable high transmit power level over a SAR time window than for other SAR limits available for use by the transmitter of the wireless device. In some embodiments, the one or more processors of the wireless device can be configured to select the body-extremity-adjacent SAR limit for terrestrial cellular wireless communications under certain conditions, such as when certain applications are being actively used. Exemplary applications that may be used with the body-extremity-adjacent SAR limit include a video call with active face detection, an emergency services video call, an active application use with scrolling and/or tapping detected, or an active application using a camera associated with the wireless device.

Other aspects and advantages of the invention will become apparent from the following detailed description taken in conjunction with the accompanying drawings which illustrate, by way of example, the principles of the described embodiments.

This Summary is provided merely for purposes of summarizing some example embodiments so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

The disclosure will be readily understood by the following detailed description in conjunction with the accompanying drawings, wherein like reference numerals designate like structural elements.

FIG. 1 illustrates a block diagram of different components of an exemplary system configured to adapt communication parameters for a wireless device, according to some embodiments.

FIG. 2 illustrates a block diagram of a more detailed view of exemplary components of a wireless device of the system of FIG. 1, according to some embodiments.

FIG. 3 illustrates a block diagram of exemplary modules of a wireless device used for determining a specific absorption rate (SAR) limit, according to some embodiments.

FIG. 4 illustrates a flow diagram of an exemplary technique to determine a SAR limit for a wireless device, according to some embodiments.

FIG. 5 illustrates a block diagram of exemplary elements of a wireless device, according to some embodiments.

### DETAILED DESCRIPTION

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

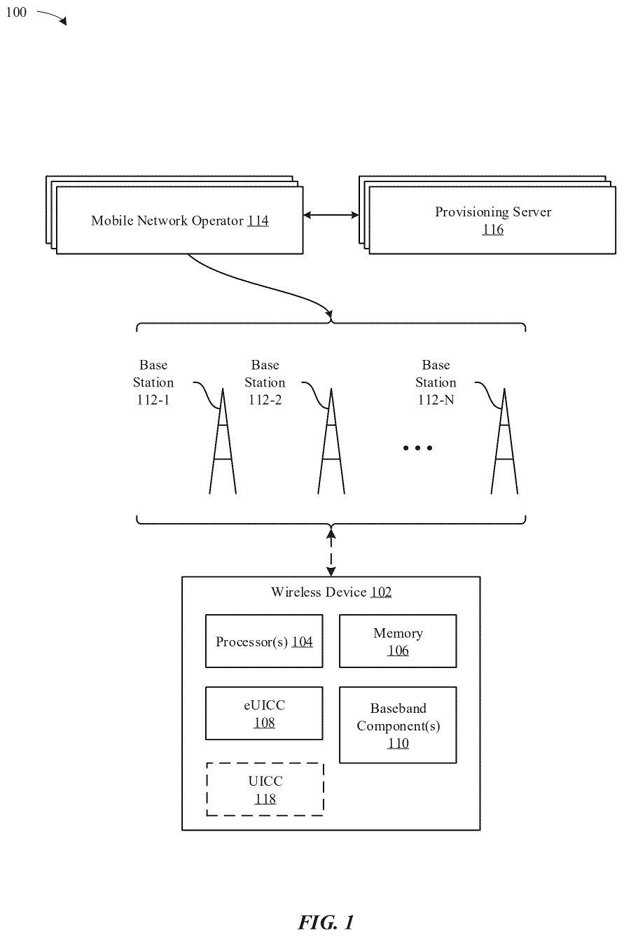

These and other embodiments are discussed below with reference to FIGS. 1 through 5; however, those skilled in the art will readily appreciate that the detailed description given herein with respect to these figures is for explanatory purposes only and should not be construed as limiting.

FIG. 1 illustrates a block diagram of different components of a system 100 that includes i) a wireless device 102, which can also be referred to as a mobile wireless device, a cellular wireless device, a wireless communication device, a mobile device, a user equipment (UE), a device, a primary wireless device, a secondary wireless device, an accessory wireless device, a cellular-capable wearable device, and the like, ii) a group of base stations 112-1 to 112-N, which are managed by different Mobile Network Operators (MNOs) 114, and iii) a set of provisioning servers 116 that are in communication with the MNOs 114. The wireless device 102 can represent a mobile computing device (e.g., a phone, a tablet, a peripheral device, etc.), the base stations 112-1 to 112-N can represent cellular radio access network (RAN) entities including fourth generation (4G) Long Term Evolution (LTE) evolved NodeBs (eNodeBs or eNBs), fifth generation (5G) NodeBs (gNodeBs or gNBs), and/or sixth generation (6G) NodeBs that are configured to communicate with the wireless device 102. Each of the base stations 112-1 to 112-n can be a single entity, quasi-collocated entities, or separated among multiple units (e.g., Central Units (CUs), Distributed Units (DUs), Remote Units (RUs)). The MNOs 114 can represent different wireless service providers that provide specific services (e.g., voice, data, video, messaging) to which a user of the wireless device 102 can subscribe to access the services via the wireless device 102. Applications resident on the wireless device 102 can advantageously access services of a cellular wireless network provided by a wireless service provider using 4G LTE connections, 5G connections, and/or 6G connections (when available) via one or more base stations 112.

As shown in FIG. 1, the wireless device 102 can include processing circuitry, which can include one or more processors 104 and a memory 106, an embedded Universal Integrated Circuit Card (eUICC) 108, and/or integrated UICC (iUICC) (not shown) and baseband component 110 used for transmission and reception of cellular wireless radio frequency signals. In some embodiments, the wireless device 102 can include one or more universal integrated circuit cards (UICCs) 118, also referred to as physical SIM cards, each UICC 118 including a SIM, in addition to or in place of the eUICC 108 providing one or more electronic SIMs (eSIMs) and/or an iUICC providing one or more eSIMs. A wireless device 102 that includes multiple active (enabled) SIMs and/or eSIMs can be referred to generally herein as a multi-SIM/eSIM wireless device. The one or more processors 104 can include one or more wireless processors, such as a cellular baseband component, a wireless local area network processor, a wireless personal area network processor, a near-field communication processor, and one or more system-level application processors. The components of the wireless device 102 work together to enable the wireless device 102 to provide useful features to a user of the wireless device 102, such as cellular wireless network access, non-cellular wireless network access, localized computing, location-based services, and Internet connectivity. Although depicted as distinct blocks, the various components (e.g., memory 106, processor(s) 104, eUICC 108, baseband component 110, and UICC 118) can be arranged and combined in any number of configurations.

The eUICC 108 can be configured to store multiple eSIMs for accessing services offered by one or more different MNOs 114 via communication through base stations 112-1 to 112-N. To be able to access services provided by the MNOs, one or more eSIMs can be provisioned to the eUICC 108 of the wireless device 102. The wireless device 102 can include wireless circuitry, including the baseband component 110 and at least one transmitter/receiver, also referred to as a transceiver. In some embodiments, the wireless device 102 includes two or more transceivers.

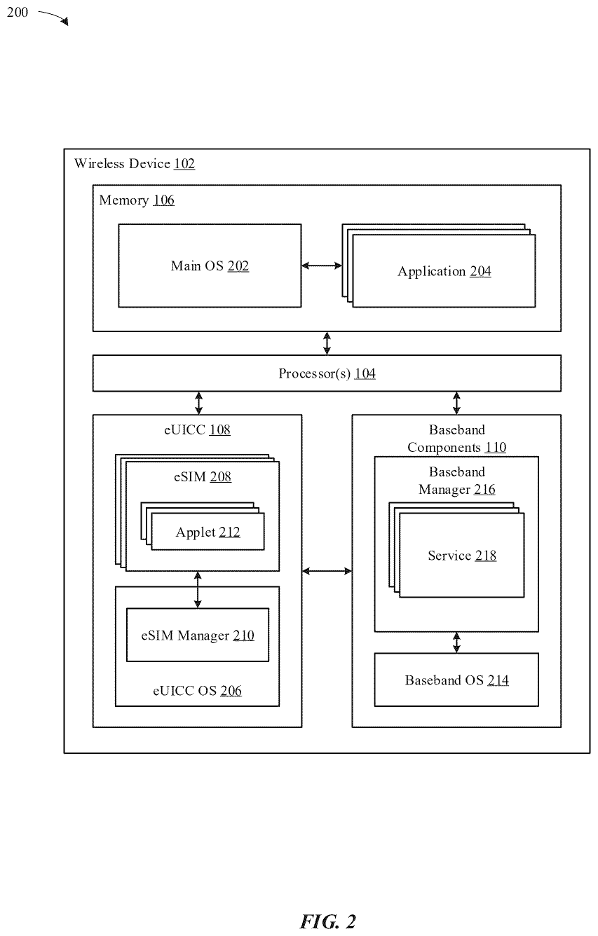

FIG. 2 illustrates a block diagram 200 of a more detailed view of exemplary components of a wireless device 102 of the system 100 of FIG. 1. The one or more processors 104, in conjunction with the memory 106, can implement a main operating system (OS) 202 that is configured to execute applications 204 (e.g., native OS applications and user applications). The one or more processors 104 can include applications processing circuitry and, in some embodiments, wireless communications control circuitry. The applications processing circuitry can monitor application requirements and usage to determine recommendations about communication connection properties, such as bandwidth and/or latency, and provide information to the communications control circuitry to determine suitable wireless connections for use by particular applications. The communications control circuitry can process information from the applications processing circuitry as well as from additional circuitry, such as the baseband component 110, and other sensors (not shown) to determine states of components of the wireless device 102, e.g., reduced power modes, as well as of the wireless device 102 as a whole, e.g., mobility states, activity/inactivity states. The wireless device 102 further includes an eUICC 108 that can be configured to implement an eUICC OS 206 to manage the hardware resources of the eUICC 108 (e.g., a processor and a memory embedded in the eUICC 108). The eUICC OS 206 can also be configured to manage eSIMs 208 that are stored by the eUICC 108, e.g., by enabling, disabling, modifying, updating, or otherwise performing management of the eSIMs 208 within the eUICC 108 and providing the baseband component 110 with access to the eSIMs 208 to provide access to wireless services for the wireless device 102. The eUICC OS 206 can include an eSIM manager 210, which can perform management functions for various eSIMs 208. Each eSIM 208 can include a number of applets 212 that define the manner in which the eSIM 208 operates. For example, one or more of the applets 212, when implemented by the baseband component 110 and the eUICC 108, can be configured to enable the wireless device 102 to communicate with an MNO 114 and provide useful features (e.g., phone calls and internet) to a user of the wireless device 102.

The baseband component 110 of the wireless device 102 can include a baseband OS 214 that is configured to manage hardware resources of the baseband component 110 (e.g., a processor, a memory, different radio components, etc.). The baseband component 110 (or a portion thereof) can also be referred to as a baseband component, a wireless baseband component, a baseband wireless processor, a cellular baseband component, a cellular component, and the like. According to some embodiments, the baseband component 110 can implement a baseband manager 216 that is configured to interface with the eUICC 108 to establish a secure channel with a provisioning server 116 and obtain information (such as eSIM data) from the provisioning server 116 for purposes of managing eSIMs 208. The baseband manager 216 can be configured to implement services 218, which represent a collection of software modules that are instantiated by way of the various applets 212 of enabled eSIMs 208 that are included in the eUICC 108. For example, services 218 can be configured to manage different connections between the wireless device 102 and MNOs 114 according to the different eSIMs 208 that are enabled within the eUICC 108.

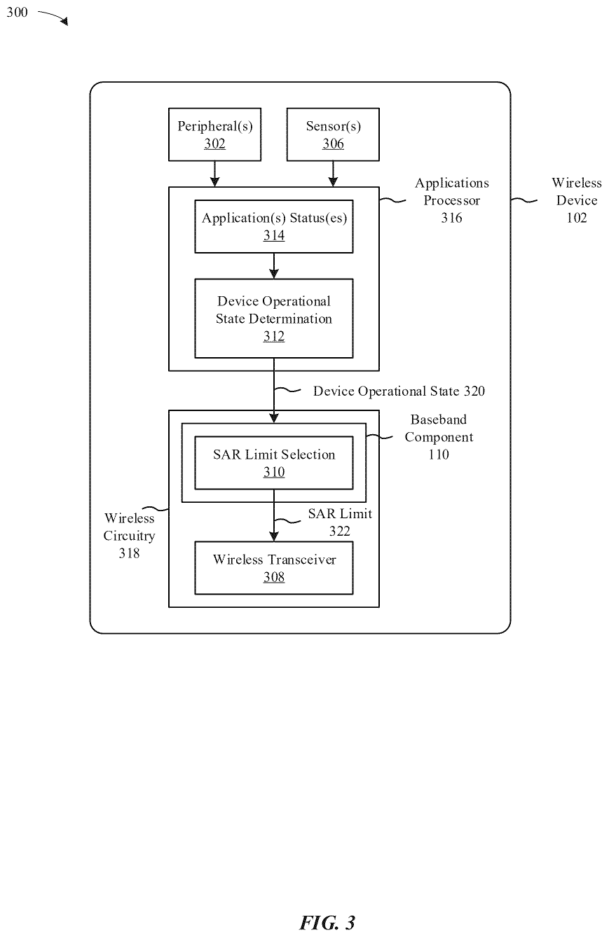

FIG. 3 illustrates a block diagram 300 of components of an exemplary wireless device 102 configurable for adaptive determination and use of specific absorption rate (SAR) limits. The wireless device 102 includes an applications processor 316, which can be one of the processors 104 shown in the wireless device 102 of FIG. 2. The wireless device 102 further includes one or more peripherals 302 that can provide input to the applications processor, such as a camera, a microphone, or the like. In some embodiments, information available from one or more peripherals 302 can be used to assist in determining a SAR limit to use for the wireless device 102. The wireless device 102 also includes one or more sensors 306 that also provide information to the applications processor 316. Exemplary sensors 306 can include a light detector, a motion sensor, a temperature sensor, an altimeter, a capacitive contact sensor, etc. Information provided by one or more sensors to the applications processor 316 may also be used, in some embodiments, when determining an applicable SAR limit to apply for cellular wireless transmissions from the wireless device 102. The applications processor 316 can execute instructions for one or more applications 204 resident on the wireless device 102, and application statuses 314 of the one or more applications 204 can be used by a device operational state determination module 312 that determines properties of the operational state of the wireless device 102, based at least in part on one or more application statuses 314. In some embodiments, the wireless device 102 includes information regarding applicable uses of the wireless device for different applications. In some embodiments, the wireless device 102 accounts for an application status 314, e.g., foreground, background, active, inactive, as well as an application type, e.g., video conferencing, voice call, emergency services video call, Internet browsing session, videogame, active application with scrolling and/or tapping detected, active application using a camera associated with the wireless device, etc., when determining a device operational state 320 of the wireless device 102.

The wireless device 102 includes wireless circuitry 318, e.g., a wireless transceiver 308, which can include components to convert data into radio frequency signals for cellular wireless transmission by the wireless device 102. The wireless circuitry 318 also receives radio frequency signals to process and provide to the baseband component 110. The wireless transceiver 308 can include one or more wireless transmitters and one or more wireless receivers connected to one or more antennas. The wireless transceiver receives one or more control signals (in addition to data) from the baseband component 110, where at least one or more control signals can indicate a SAR limit 322 for the wireless transceiver 308 to use. In some embodiments, the baseband component 110 uses the SAR limit 322 to control signals sent to the wireless transceiver 308. In some embodiments, the wireless transceiver 308 uses the SAR limit 322 to determine usable settings for configuring hardware that transmit radio frequency signals and to ensure that the wireless device 102 abides by the SAR limit 322 indicated. In some embodiments, operations by the baseband component 110 ensure that transmitted radio frequency signals from the wireless device 102 satisfy the SAR limit 322. In some embodiments, a SAR limit selection module 310 in the baseband component 110 determines which SAR limit, of multiple SAR limits available, to configure operation of the wireless circuitry 318, including the wireless transceiver 308, based on the device operational state 320 information provided by the applications processor 316. In some embodiments, the SAR limit selection module 310 determines the SAR limit 322 based at least in part on the device operational state 320 obtained from the applications processor 316, where the device operational state 320 accounts for statuses of one or more applications of the wireless device 102. In some embodiments, the applications processor 316 processes information from one or more peripherals 302 and/or from one or more sensors 306 to determine a manner in which a wireless device 102 is being used and what device operational state 320 information to provide to the baseband component 110 to influence selection of a SAR limit.

A wireless device 102 can comply with SAR limit regulations imposed by various regulatory bodies in different geographic regions, such as the Federal Communications Commission (FCC) in the United States, where the SAR limit ensures that an average amount of radiated radio frequency energy per unit time (power) over various time windows does not exceed certain limits. SAR limits can be specified for different radio frequency technologies, e.g., fourth generation (4G) long term evolution (LTE), fifth generation (5G) new radio (NR), Bluetooth, Wi-Fi, etc. SAR limits can also vary based on a range of radio frequencies used, an amount of radio frequency bandwidth used, a particular wireless device transmission antenna port, etc. Furthermore, SAR limits have been standardized for different positions of a transmitting wireless device 102 relative to a user's human body or portions thereof. In particular, there exist different SAR limits for a head-adjacent position, for a body-adjacent position, for a body-extremity-adjacent position, and for a free space position. SAR limits are most restrictive for head-adjacent positions and least restrictive for free space positioning. A body-extremity SAR limit, for a body-extremity-adjacent position, allows for a wireless device 102 to transmit a higher amount of sustained transmit power during a SAR time window than a body SAR limit, for a body-adjacent position. An example of a body-extremity-adjacent position is use of a wireless device 102 in a user's hand away from the user's body core. With effective algorithms in the wireless device 102 and/or by recognizing that a particular application is in use, where that application is intended to be used or is restricted for use at a body extremity, the wireless device 102 can use the body-extremity SAR limit, which can provide a higher limit on the amount of sustained transmit power that the wireless device 102 can use, averaged over a certain time period, rather than be limited to a lower sustained transmit power limit over the same time period, as would be specified by a body SAR limit or a head SAR limit. Thus, when an application of the wireless device 102 is being used, an application for which there is no ambiguity regarding positional use of the wireless device 102, the body-extremity SAR limit can be available for use by the wireless device 102 to configure the transmitter of the wireless device 102. In some embodiments, the wireless device 102 includes a classifier process that determines how the wireless device 102 is being used, e.g., whether the wireless device 102 is being used at a body extremity, such as when the wireless device 102 is handheld away from the body of the user. The classifier process can provide information to the device operational state determination module 312 to influence selection of the device operational state 320 to provide to the SAR limit selection module 310 of the baseband component 110 of the wireless device 102. In some embodiments, the information available to the device operational state determination module 312 (or to other modules) of the applications processor 316 is provided to the baseband component 110 in place of in addition to the device operational state 320 to assist the SAR limit selection module 310 to determine the SAR limit to apply to cellular wireless transmissions by the wireless device 102.

Present configurations of cellular wireless devices restrict the use of body-extremity SAR limits to select applications other than terrestrial cellular wireless communication, such as for emergency wireless signal transmissions to a satellite. As described herein, the body-extremity SAR limit can be extended to be used for terrestrial cellular wireless transmission when a determination that the wireless device 102 is being used (or is most likely being used) at a body extremity, such as when particular applications are in active use by the wireless device 102. Exemplary applications include: i) a video call, which can also include face detection, ii) an emergency services live video call, where live videos can be shared with emergency dispatchers, iii) active Internet browsing or social media application scrolling and tapping to indicate reading of the screen with the wireless device at a body extremity, iv) a live video broadcast for a social media or other video application, v) a scanning application such as for a quick response (QR) code.

Generally, a wireless device 102 transmits at or near a maximum transmit power level when data throughput is low, with spaced high power transmissions interspersed with quiet periods, without nearing a SAR limit. When the wireless device 102 is transmitting at a high data throughput rate, and particularly during lower signal quality conditions, the wireless device 102 will transmit at power levels nearer to (or nearing) the SAR limit, and therefore, application of a higher SAR limit, when available, can provide improvements in data throughput, latency, and a higher amount of power budget available (and therefore a lower power budget consumption for transmission) than when using a lower SAR limit.

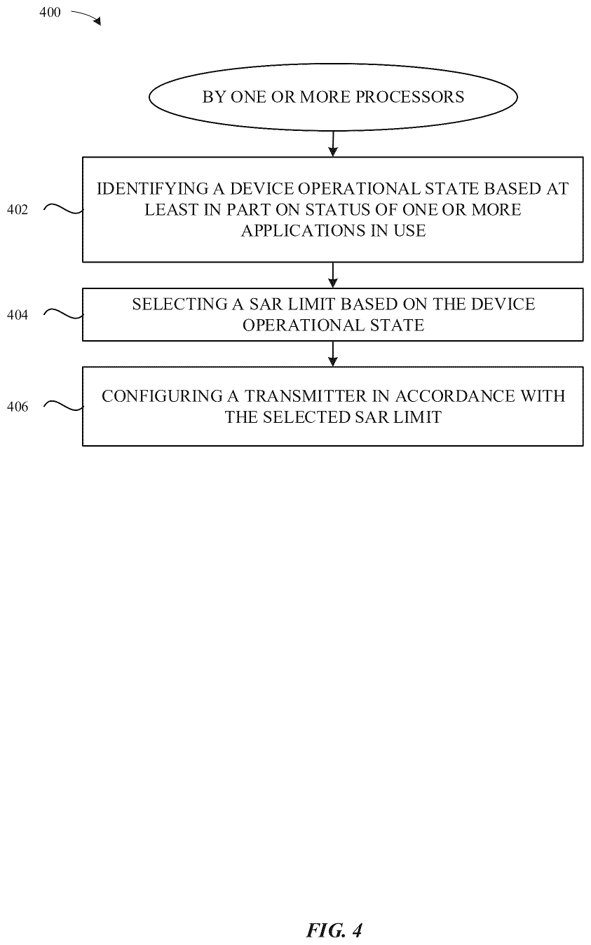

FIG. 4 illustrates a flow chart 400 of an exemplary method performed by one or more processors to determine and apply a SAR limit 322. In some embodiments, the one or more processors are included in a device, such as a wireless device 102. At 402, the one or more processors identify a device operational state 320 based at least in part on status of one or more applications in use. In some embodiments, the device operational state 320 includes one or more operational states of hardware, software, and/or firmware of a device, such as a wireless device 102, and/or of components and/or modules included therein. At 404, the one or more processors select a SAR limit 322 based on the identified device operational state 320. At 406, the one or more processors configure a transmitter in accordance with the selected SAR limit 322. In some embodiments, the transmitter is included in a component, such as a transceiver of a device, such as a wireless device 102.

In some embodiments, selection of a SAR limit can be based on a determination of use of the transmitter (or of a device in which the transmitter is included) relative to a user of the transmitter/device, e.g., relative to a user's head, a user's body, and/or at a user's body extremity. In some embodiments, the transmitter is associated with a device, such as wireless device 102, and the device operational state 320 includes information regarding a position of the transmitter associated with the device relative to a user of the device associated with the transmitter. In some embodiments, a head SAR limit is selected when the device operational state 320 indicates use of the transmitter adjacent to a head of a user of a wireless device associated with the transmitter. In some embodiments, a body SAR limit is selected when the device operational state 320 indicates use of the transmitter adjacent to a body of a user of a wireless device associated with the transmitter. In some embodiments, a body-extremity SAR limit is selected when the device operational state 320 indicates use of the transmitter at a body extremity of a user of a wireless device associated the transmitter. In some embodiments, identification of the device operational state 320 includes detection based on information provided by one or more sensors 306. In some embodiments, identification of the device operational state 320 includes detection of active foreground use of an application 204. In some embodiments, the device operational state 320 indicates use of a wireless device 102 associated with the transmitter at a body extremity of the user based on a predetermined use of the application 204 at a body extremity position. In some embodiments, the method further includes transmitting terrestrial cellular wireless signals to a base station 112 while configured with a body-extremity SAR limit during use of the application 204. In some embodiments, the application 204 includes one of: i) a video call with active face detection, ii) an emergency services video call, iii) an active application use with scrolling and/or tapping detected, or iv) an active application using a camera associated with the wireless device 102.

### Representative Exemplary Apparatus

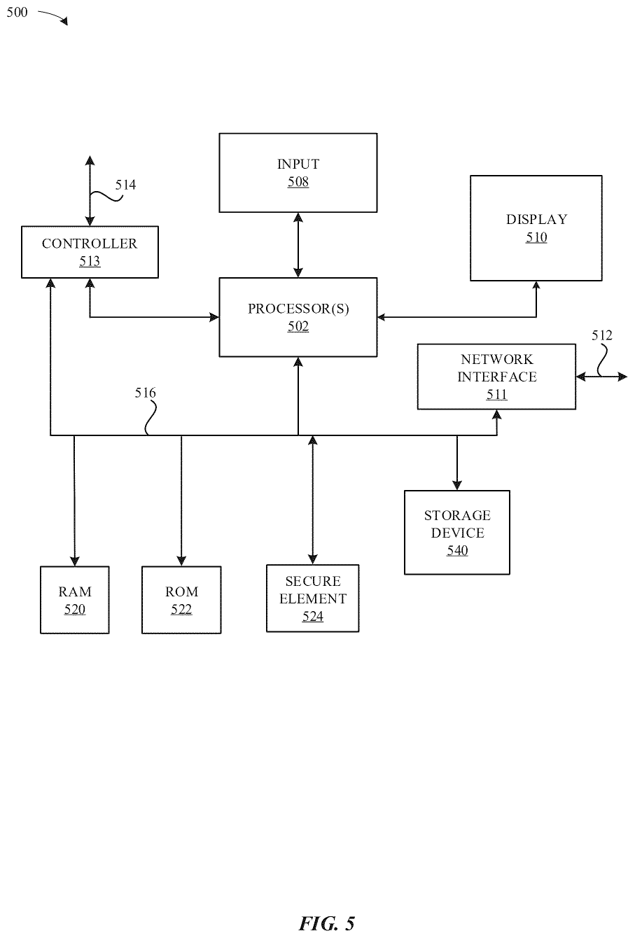

FIG. 5 illustrates in block diagram format an exemplary computing device 500 that can be used to implement the various components and techniques described herein, according to some embodiments. In particular, the detailed view of the exemplary computing device 500 illustrates various components that can be included in the wireless device 102. As shown in FIG. 5, the computing device 500 can include one or more processors 502 that represent microprocessors or controllers for controlling the overall operation of computing device 500. In some embodiments, the computing device 500 can also include a user input device 508 that allows a user of the computing device 500 to interact with the computing device 500. For example, in some embodiments, the user input device 508 can take a variety of forms, such as a button, keypad, dial, touch screen, audio input interface, visual/image capture input interface, input in the form of sensor data, etc. In some embodiments, the computing device 500 can include a display 510 (screen display) that can be controlled by the processor(s) 502 to display information to the user (for example, information relating to incoming, outgoing, or active communication sessions). A data bus 516 can facilitate data transfer between at least a storage device 540, the processor(s) 502, and a controller 513. The controller 513 can be used to interface with and control different equipment through an equipment control bus 514. The computing device 500 can also include a network/bus interface 511 that couples to a data link 512. In the case of a wireless connection, the network/bus interface 511 can include wireless circuitry, such as a wireless transceiver and/or baseband component. The computing device 500 can also include a secure element 524. The secure element 524 can include an eUICC 108, an iUICC, and/or one or more UICCs 118.

The computing device 500 also includes a storage device 540, which can include a single storage or a plurality of storages (e.g., hard drives and/or solid-state drives), and includes a storage management module that manages one or more partitions within the storage device 540. In some embodiments, storage device 540 can include flash memory, semiconductor (solid state) memory or the like. The computing device 500 can also include a Random-Access Memory (RAM) 520 and a Read-Only Memory (ROM) 522. The ROM 522 can store programs, utilities or processes to be executed in a non-volatile manner. The RAM 520 can provide volatile data storage, and stores instructions related to the operation of the computing device 500.

### Wireless Terminology

In accordance with various embodiments described herein, the terms “wireless communication device,” “wireless device,” “mobile device,” “mobile station,” “mobile wireless device,” and “user equipment” (UE) may be used interchangeably herein to describe one or more consumer electronic devices that may be capable of performing procedures associated with various embodiments of the disclosure. In accordance with various implementations, any one of these consumer electronic devices may relate to: a cellular phone or a smart phone, a tablet computer, a laptop computer, a notebook computer, a personal computer, a netbook computer, a media player device, an electronic book device, a MiFi® device, a wearable computing device, as well as any other type of electronic computing device having wireless communication capability that can include communication via one or more wireless communication protocols such as used for communication on: a wireless wide area network (WWAN), a wireless metro area network (WMAN) a wireless local area network (WLAN), a wireless personal area network (WPAN), a near-field communication (NFC), a cellular wireless network, a fourth generation (4G) LTE, LTE Advanced (LTE-A), 5G, and/or 6G or other present or future developed advanced cellular wireless networks.

The wireless device, in some embodiments, can also operate as part of a wireless communication system, which can include a set of client devices, which can also be referred to as stations, client wireless devices, or client wireless communication devices, interconnected to an access point (AP), e.g., as part of a WLAN, and/or to each other, e.g., as part of a WPAN and/or an “ad hoc” wireless network. In some embodiments, the client device can be any wireless device that is capable of communicating via a WLAN technology, e.g., in accordance with a wireless local area network communication protocol. In some embodiments, the WLAN technology can include a Wi-Fi (or more generically a WLAN) wireless communication subsystem or radio, the Wi-Fi radio can implement an Institute of Electrical and Electronics Engineers (IEEE) 802.11 technology, such as one or more of: IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies.

Additionally, it should be understood that the UEs described herein may be configured as multi-mode wireless devices that are also capable of communicating via different radio access technologies (RATs). In these scenarios, a multi-mode user equipment (UE) can be configured to prefer attachment to a 5G wireless network offering faster data rate throughput, as compared to other 4G LTE legacy networks offering lower data rate throughputs. For instance, in some implementations, a multi-mode UE may be configured to fall back to a 4G LTE network or a 3G legacy network, e.g., an Evolved High Speed Packet Access (HSPA+) network or a Code Division Multiple Access (CDMA) 2000 Evolution-Data Only (EV-DO) network, when 5G wireless networks are otherwise unavailable.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a non-transitory computer readable medium. The non-transitory computer readable medium is any data storage device that can store data which can thereafter be read by a computer system. Examples of the non-transitory computer readable medium include read-only memory, random-access memory, CD-ROMs, HDDs, DVDs, magnetic tape, and optical data storage devices. The non-transitory computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method to select and use a specific absorption rate (SAR) limit for a transmitter, the method comprising:
by one or more processors:
identifying a device operational state based at least in part on status of one or more applications in use;
selecting a SAR limit based on the device operational state; and
configuring the transmitter in accordance with the selected SAR limit.

2. The method of claim 1, wherein:
a head SAR limit is selected when the device operational state indicates use of the transmitter adjacent to a head of a user of a wireless device associated with the transmitter;
a body SAR limit is selected when the device operational state indicates use of the transmitter adjacent to a body of the user of the wireless device associated with the transmitter; and
a body-extremity SAR limit is selected when the device operational state indicates use of the transmitter at a body extremity of the user of the wireless device associated with the transmitter.

3. The method of claim 1, wherein:
identification of the device operational state includes detection based on information provided by one or more sensors.

4. The method of claim 1, wherein:
identification of the device operational state includes detection of active foreground use of an application.

5. The method of claim 4, wherein:
the device operational state indicates use of a wireless device associated with the transmitter at a body extremity of a user based on a predetermined use of the application at a body extremity position.

6. The method of claim 5, wherein the method further comprises transmitting terrestrial cellular wireless signals to a base station while configured with a body-extremity SAR limit during use of the application.

7. The method of claim 5, wherein the application comprises one of:
a video call with active face detection;
an emergency services video call;
an active application use with scrolling and/or tapping detected; or
an active application using a camera associated with the wireless device.

8. An apparatus to select and use a specific absorption rate (SAR) limit for a transmitter, the apparatus comprising one or more processors communicatively coupled to a memory storing instructions, the one or more processors configured to:
identify a device operational state based at least in part on status of one or more applications in use;
select a SAR limit based on the device operational state; and
configure a transmitter to transmit in accordance with the selected SAR limit.

9. The apparatus of claim 8, wherein:
a head SAR limit is selected when the device operational state indicates use of the transmitter adjacent to a head of a user of a wireless device associated with the transmitter;
a body SAR limit is selected when the device operational state indicates use of the transmitter adjacent to a body of the user of the wireless device associated with the transmitter; and
a body-extremity SAR limit is selected when the device operational state indicates use of the transmitter at a body extremity of the user of the wireless device associated with the transmitter.

10. The apparatus of claim 8, wherein:
identification of the device operational state includes detection based on information provided by one or more sensors.

11. The apparatus of claim 8, wherein:
identification of the device operational state includes detection of active foreground use of an application.

12. The apparatus of claim 11, wherein:
the device operational state indicates use of a wireless device associated with the transmitter at a body extremity of a user based on a predetermined use of the application at a body extremity position.

13. The apparatus of claim 12, wherein the one or more processors are further configured to:
transmit terrestrial cellular wireless signals to a base station while configured with a body-extremity SAR limit during use of the application.

14. The apparatus of claim 12, wherein the application comprises one of:
a video call with active face detection;
an emergency services video call;
an active application use with scrolling and/or tapping detected; or
an active application using a camera associated with the wireless device.

15. A non-transitory computer-readable medium storing instructions for selection and use of a specific absorption rate (SAR) limit for a transmitter, the instructions comprising:
instructions for identifying a device operational state based at least in part on status of one or more applications in use;
instructions for selecting a SAR limit based on the device operational state; and
instructions for configuring the transmitter in accordance with the selected SAR limit.

16. The non-transitory computer-readable medium of claim 15, wherein:
a head SAR limit is selected when the device operational state indicates use of the transmitter adjacent to a head of a user of a wireless device associated with the transmitter;
a body SAR limit is selected when the device operational state indicates use of the transmitter adjacent to a body of the user of the wireless device associated with the transmitter; and
a body-extremity SAR limit is selected when the device operational state indicates use of the transmitter at a body extremity of the user of the wireless device associated with the transmitter.

17. The non-transitory computer-readable medium of claim 15, wherein:
identification of the device operational state includes detection of active foreground use of an application.

18. The non-transitory computer-readable medium of claim 17, wherein:
the device operational state indicates use of a wireless device associated with the transmitter at a body extremity of a user based on a predetermined use of the application at a body extremity position.

19. The non-transitory computer-readable medium of claim 18, wherein the instructions further comprise:
instructions for transmitting terrestrial cellular wireless signals to a base station while configured with a body-extremity SAR limit during use of the application.

20. The non-transitory computer-readable medium of claim 18, wherein the application comprises one of:
a video call with active face detection;
an emergency services video call;
an active application use with scrolling and/or tapping detected; or
an active application using a camera associated with the wireless device.
